(19) United States
(12) Patent Application Publication
(10) Pub. No.: US 2017/0061539 A1
(43) Pub. Date: Mar. 2, 2017

(54) TRADING SYSTEM AND METHOD

(71) Applicant: Complii FinTech Solutions Ltd, Perth (AU)

(72) Inventor: Anthony Raymond Cunningham, City Beach (AU)

(21) Appl. No.: 15/247,614

(22) Filed: Aug. 25, 2016

(30) Foreign Application Priority Data
Aug. 25, 2015 (AU) 2015903430

(51) Int. Cl. G06Q 40/04

(52) U.S. Cl. CPC G06Q 40/04

(57) ABSTRACT

Embodiments of the present invention relate to a trading system and method for providing information on trades. An embodiment of the present invention comprises an order process arranged to generate order information associated with trades on a securities trading system, the order information including identity information on the identity of clients making the trades. The system can also implements a private transfer process enabling private trades between users of the system, via a trading information interface.

### CROSS-REFERENCES TO RELATED APPLICATIONS

This application claims the benefit of Australian Patent Application No. 2015903430, filed Aug. 25, 2015, which is hereby incorporated by reference in its entirety for all purposes.

### FIELD OF THE INVENTION

The present invention relates to a trading system and method for providing information on trades, and, particularly, but not exclusively, to a securities trading system and method for providing trade information.

### BACKGROUND OF THE INVENTION

Systems which facilitate trading on centralized markets such as the ASX, CSC, New York and NASDAQ are known. These systems enable brokers and other licensed traders to undertake electronic transactions on behalf of clients. The systems may include complex hardware and software systems implementing “matching engines”, that enable matching of “Bids” and “Asks” so that trades can take place. Brokers and other licensed traders have software/hardware systems which can interface with the stock market systems so that they can undertake trading.

Systems are also known which enable individuals (“clients”) to trade on stock markets. In Australia, for example, systems such as COMMSEC™ cater to the retail trade, and enable individuals to trade on the ASX (via electronic trading interfaces such as IRESS™).

Equivalent systems in other jurisdictions allow brokers, licensed traders and the retail trade to trade on other countries' stock markets.

Stock exchange systems can provide real-time trading information, facilitating price discovery. At the exchange level they provide information as to the facilitating broker. However, they do not provide any facility to obtain live information on other parameters, such as the identity of individuals or companies trading. Any individual, company or organisation (not being a broker) trading on an exchange are generally limited to trading anonymously.

### BRIEF SUMMARY OF THE INVENTION

In accordance with a first aspect, the present invention provides a system for providing trade information, comprising a computer having a processor, a memory and an operating system supporting computer processes, an order process enabling a client to place orders for trading, and arranged to generate order information associated with trades, the order information including identity information on the identity of clients making the trades.

A “client” may be any individual, organisation, company, collection of individuals who are trading or intend to trade in securities or other equities via the system.

In an embodiment, the system is arranged to provide pre-trade bids and asks information and may also provide post-trade information.

In an embodiment, the order process enables placing of trading orders on a stock market system, so that securities or other property may be traded.

In an embodiment, the system comprises a trade information interface which is arranged to display the order information for access by clients. Clients are therefore able to access this “published” order information. In an embodiment, therefore, securities or other property may be traded with visibility to some or all other users.

In an embodiment, the system comprises a client selection mechanism, enabling a client to select whether or not order information associated with them will be displayed. In an embodiment, the client selection mechanism enables the client to select identity information to be displayed. In an embodiment, the identity information may include an identity of the client. In an embodiment the identity information is an anonymous identity.

In an embodiment, the client selection mechanism enables a client to select what type of order information may be displayed. For example, order information may be displayed post-trade or pre-trade (bids and/or asks information) or both.

In an embodiment, an advantage of facilitating publication of identity information and order information is to provide guidance to other traders. Other traders may be aware of the reputation of the trader (client) whose identity is displayed, for example. Even published anonymous orders can provide guidance that people are trading in particular shares. The ability of a client to select whether their order information is published, can facilitate engagement in trading by persons.

In an embodiment, when a client places an order via the order process, the order process is arranged to capture order information, including identity information, in data records in a database. In an embodiment, the trade information interface includes fields in which the order process may enter order information, including identity information, from the data records, for publication.

In an embodiment, the order process provides an order process interface via which the client may place their orders for trading. In an embodiment, the selector mechanism comprises a selector device in the order process interface enabling selection of whether or not order information and what order information will be displayed.

In an embodiment, the system includes a communications arrangement enabling clients to communicate with the order process via remote devices. The remote devices may include laptop computers, PCs, smart phones, tablets or any other remote devices. The order process is arranged to present the order process interface via the remote devices.

In an embodiment, the system comprises a communications process enabling clients to communicate information, messages etc. The communications process is arranged to post the communications/messages on the trade information interface, for viewing by other clients. The posting may be in the form of a “blog”. Clients may have “conversations” around particular orders, for example. They may choose to reveal their orders etc. in a message. This advantageously increases interest and engagement in trading.

In an embodiment, the system has the advantage that it allows for greater transparency and social interaction, similar to that which was present in the traditional “open outcry” financial trading system, assuming the buying or selling broker was willing to identify the buyer or seller they were buying or selling for or if people could assume that by using that broker it was most likely to be a certain group or individual. This is now missing in modern electronic trading.

In an embodiment, the order process comprises a private transfer process, which is arranged to enable a private trade between clients having access to the system. Clients may trade off the exchange. In an embodiment, this system may comprise a transfer engine, or may utilise a transfer engine, to implement the private transfer. This is often called a Dark Pool.

In an embodiment, the system comprises a private communications process, enabling to two or more clients to communicate with each other privately. Clients may send private messages to each other, for example, regarding trades or information about trades or any other information. In the embodiment where the order process comprises a private transfer process, clients may use the private communication process to send messages and agree to use the private transfer process for a trade of property owned by the clients, for example.

In accordance with a second aspect, the present invention provides a method of providing trade information, comprising the steps of enabling a client to place orders for trades, generating order information associated with the trades, the order information including identity information on the identity of clients making the trades.

In an embodiment, the method comprises the step of displaying the order information for access by clients.

In an embodiment, the method comprises the further step of enabling a client to select whether or not order information associated with them will be displayed. The method also comprises the step of enabling the client to select what type of order information is displayed. For example, order information may be displayed post-trade or pre-trade, or both.

In an embodiment, the method comprises the further step of implementing a private transfer process, enabling a private trade between clients. The private transfer process may enable trading off-exchange or in a dark pool.

In an embodiment, the method comprises the further step of facilitating a private communication between two or more clients, enabling them to send private messages to each other regarding trades or information about trades or any other information. In embodiments, the clients may send messages to each other to agree a private trade or just chat in general.

In accordance with a third aspect, the present invention provides a computer program, comprising instructions for controlling a computer to implement a system in accordance with the first aspect of the invention.

In accordance with a fourth aspect, the present invention provides a computer readable medium, providing a computer program in accordance with a third aspect of the invention.

In accordance with a fifth aspect, the present invention provides a data signal, comprising a computer program in accordance with the third aspect of the invention.

In accordance with a sixth aspect, the present invention provides a system for providing trade information, comprising a computer having a processor, a memory and an operating system supporting computer processes, an order process arranged to generate order information associated with trades, the order information including identity information on the identity of clients making the trades.

In an embodiment, the system comprises a trade information interface which is arranged to display the order information for access by clients. Clients are therefore able to access this “published” information.

In an embodiment, the trading system comprises a client selection mechanism, enabling a client to select whether or not order information associated with them will be displayed.

In an embodiment, the order process comprises a private transfer process, which is arranged to enable a private trade between clients having access to the system. Clients may trade off the exchange. In an embodiment, the system may comprise a transfer engine, or utilize a transfer engine, to implement the private transfer.

In an embodiment, the system comprises a private communication process enabling two or more clients to communicate with each other privately. Clients may send private messages to each other regarding trades or information about trades or any other information. In the embodiment which includes private transfer process, the clients may send messages to agree a trade.

In accordance with a seventh aspect, the present invention provides a method of providing trade information, comprising the steps of generating order information associated with clients trades, the order information including identity information of clients making the trades.

In an embodiment, the method comprises the further step of displaying the order information in a trade information interface.

In accordance with an eighth aspect, the present invention provides a computer program, comprising instructions for controlling a computer to implement a system in accordance with the sixth aspect of the invention.

In accordance with a ninth aspect, the present invention provides a computer readable medium, providing a computer program in accordance with the eighth aspect of the invention.

In accordance with a tenth aspect, the present invention provides a data signal, comprising a computer program in accordance with the eighth aspect of the invention.

In accordance with an eleventh aspect, the present invention provides a system for providing trade information, comprising a computer having a processor, a memory and an operating system supporting computer processes, a trade information interface enabling the provision of trade information, and a private transfer process, arranged to enable a private trade between clients having access to the system.

In an embodiment, the system comprises a transfer engine, or may utilize a transfer engine to implement the private transfer. Clients may trade off the exchange.

In an embodiment, the system includes a private communications process enabling two or more clients to communicate with each other privately. Clients may send private messages to each other regarding trades or information about trades or any other information. The clients may send messages to each other to agree a trade.

In accordance with a twelfth aspect, the present invention provides a method of providing trade information, comprising the steps of generating and displaying trade information, and implementing a private transfer process, to enable a private trade between clients.

In accordance with a thirteenth aspect, the present invention provides a computer program, comprising instructions for controlling a computer to implement a system in accordance with the eleventh aspect of the invention.

In accordance with a fourteenth aspect, the present invention provides a computer readable medium, providing a computer program in accordance with the thirteenth aspect of the invention.

In accordance with a fifteenth aspect, the present invention provides a data signal, comprising a computer program in accordance with the thirteenth aspect of the invention.

### BRIEF DESCRIPTION OF THE DRAWINGS

Features and advantages of the present invention will become apparent from the following description of embodiments thereof, by way of example only, with reference to the accompanying drawings, in which:

FIG. 1 is a diagram of a trading system in accordance with an embodiment of the present invention;

FIG. 2 is a representation of a trade information interface produced by the trading system of FIG. 1;

FIG. 3 is a further view of a trading system interface produced by the trading system of FIG. 1;

FIG. 4 is a diagram of a trading system in accordance with a further embodiment of the present invention; and

FIG. 5 is a representation of a trading information interface produced by an embodiment of the present invention.

### DETAILED DESCRIPTION OF THE INVENTION

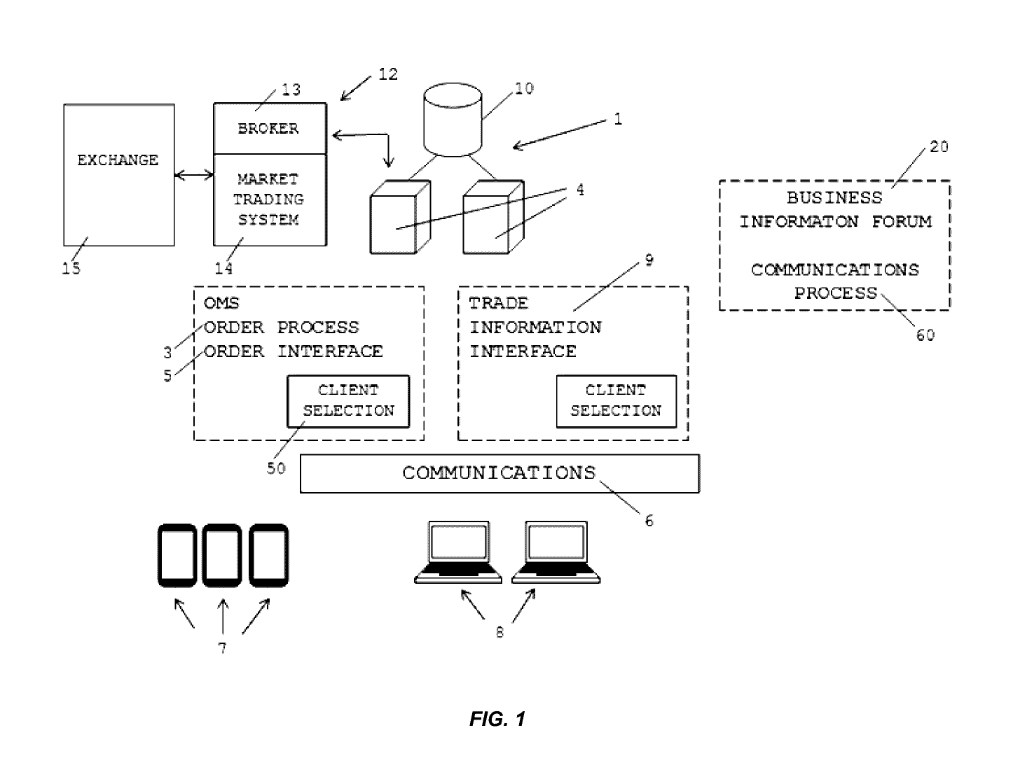

Referring to FIG. 1, a trading system in accordance with an embodiment of the present invention is designated generally by reference numeral 1. The trading system comprises an order management system 2, which includes an order process 3 implemented by server computers 4 of the trading system 1.

The order process enables clients to place trading orders for trading securities on a stock exchange. The clients may have access to the order process 3 via an order process interface 5. The order process interface is served to remote devices, by the server computers 4. The server computers implement communications interface 6 to communicate with the remote devices 7, 8.

The remote devices may comprise any communications device, including tablet computers, laptops, smart phones, PCs or any other device. These enable access by clients who wish to trade on the exchange via the trading system 1. The clients may include any clients, including retail trade (individuals), brokers, institutions or any other clients.

The order process is arranged to generate order information, including identity information on the identity of the clients making trades.

In this embodiment, the trading system also comprises a trade information interface 9 which is arranged to display the order information for access by clients. Clients are therefore able to view this published order information, including any published information on the identity of clients making the trades.

In more detail, in this embodiment, the trading system is implemented by a computing system 4 comprising one or more servers, comprising processors and memory capacity. The computing system 4 incorporates software and hardware which provides and supports various computer processes 3 and a database 10. The database 10 stores data, including data records on order information, identity information, trades and various other information.

The computer system 4 also has a communications interface 6 enabling communication with remote devices 7, 8 via available networks, such as the Internet or any other telecommunications networks. The computing system 4 also enable communications with other systems 12, which include other computing systems facilitating trade on stock exchanges. These may include broker systems 13, other trading systems 14, such as CommSec™, Pershing™ who may in turn communicate with systems trading directly on the stock exchange, such as Iress™, Reuters, Bloomberg and others 14. Communications with systems 12, 13, 14 facilitate implementation of the orders which are obtained via the order process 3 and order process interface 5.

The order process 3 may interface with a broker system 13, separate trading system 14 or exchange system directly 15. Any of these options are available.

Note that the systems referred to above, such as CommSec™, Pershing™, Iress™, GBST™, are implemented for the Australian stock market. It will be appreciated that the trading system 4 may be implemented in other jurisdictions to trade on other exchanges, using other, equivalent systems to those discussed above.

The trading system 4 in this embodiment also comprises computer processes which facilitate presentation of business information in a forum 20, which may be served as a website for clients to obtain information and also add information to the forum 20. The forum can provide a “community” of clients who may discuss matters, and may receive business information generated by other clients and by the trading system 1 and obtained from other sources via communications system 6. The trading system 4 thus combines the ability to obtain information, talk within a community and also trade on stock exchanges via the order process 3, all at one (virtual) location.

System functionality is implemented by the server 4 hardware (and other devices in the system) and associated software. These implement the computer processes and the functionality discussed above and below. The computer processes may be implemented as separate modules, which may share common foundations such as routines and sub-routines. The computer processes may be implemented in any suitable way and are not limited to separate modules. Any software/hardware architecture that implements functionality may be utilized. The system does not need to be implemented by server computers. The trading system may be immented the “cloud”. General purpose computers may be programmed to implement the system and method. The system and method may be implemented utilizing mobile devices, such as tablet computers and laptop computers, or programmable arrays and any other hardware.

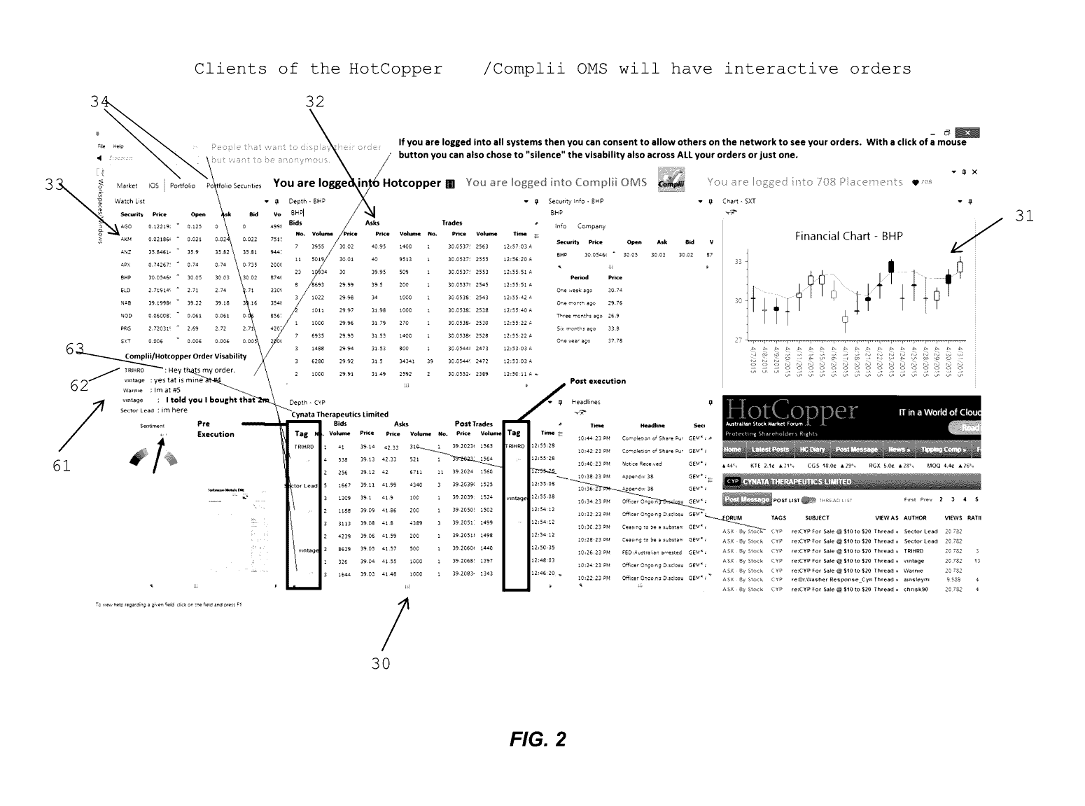

FIG. 2 shows a “view” of the trade information interface 9 that a client may see on their remote device 7, 8, being served by trading system computers 4. The trade information interface view is indicated by reference numeral 30. It can be seen that the view also provides business information in other parts of the view. This is in fact a combined interface, business information forum 20 with the trade information interface 9. The business information view is indicated by reference numeral 31. The order process interface 5 also provides an order process interface view of orders occurring on the stock market for particular shares. This includes share information, referenced at 32. A “watch list” 33 is also displayed to the client via the order process interface 5.

Various other screens may be generated by clicking on tabs 34. These screens are not shown. They may include other financial information, reports on portfolios, and other information.

Various brands and trade names are also shown in FIG. 2, including HotCopper™, Compli™, 708 Placements™. The invention is in no way limited to the use of these trade names, they are shown for illustration only.

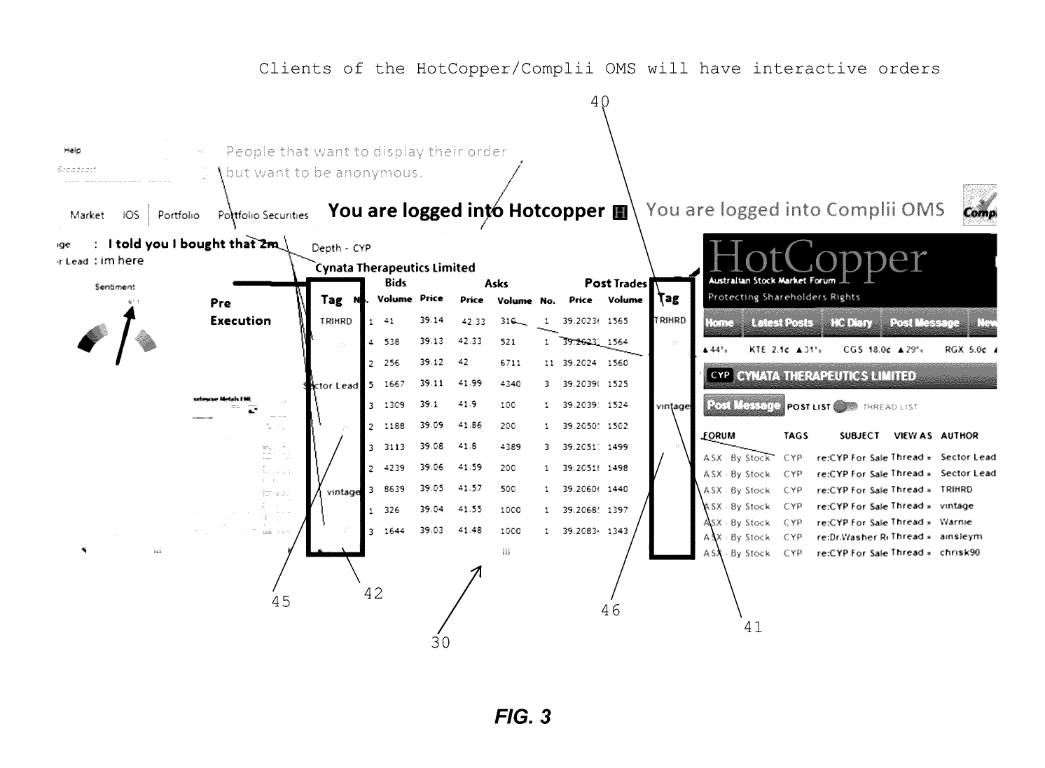

The trade information interface view 30 is shown in more detail in FIG. 3. The order process 3 is arranged to obtain order information and store the order information in data records in the database 10.

The order information will include the client identity information. The client identity information may be an identity of client which may be chosen by the client. It may be a pseudonym, for example, or a real name, or any identification information. The identifier may be an identity that the trader uses to trade under. In FIG. 3, the examples are shown at 40, “Trihard” and at 41, “Vintage”. These are both pseudonyms of individuals trading via the trading system.

The order process is arranged to store this identity information in data records.

Client selection mechanism 50 is provided via the order process interface 5. The client selection mechanism may comprise one or more “buttons”, or other means on a graphical user interface. The client selection mechanism may enable a client, for a particular trade they are undertaking, to determine whether or not that order information associated with them and the trade should be displayed on the trade information interface 9. If they select not to display any order information then no order information associated with them at all would then be displayed on the view 30. They may decide to display their identity, as Trihard and Vintage have done in this case. An option is provided for order information to be displayed at different times. For example it may be displayed before the order is completed (reference numeral 42) or after the order is completed (post-trade) reference numeral 43. Other options may be provided for display of the information.

Another option is for the client to display their order data, but not to associate it with their name. In this case, the order is displayed anonymously. See reference numeral 45 and 46.

So, if the client is logged into the system they can consent to allow others on the network to see their orders. They can also choose to “silence” the visibility across all orders or a selection or one. They can choose their identity to be displayed with the order, or they can display their order anonymously. Clients can turn on visibility orders for executed trades only (post-trade) or for all trades (pre-trade and post-trade or a combination).

The trade information interface may also include an equivalent client selection mechanism 51 to the client selection mechanism 50, so that the client can select visibility of their orders (or not) via the trade information interface 9.

In this embodiment, in order to enable the order information to be published according to the preferences of the client, the order process 3 is arranged to capture further information (over the usual price and order information) into extra fields in the database 10. The information includes the identity of the client and any “preference information” entered. “Preference information” may include that the publication of an order may occur; Whether the order is to be published with the actual identity of the client; or with a “homogenous” (anonymous) identity.

The order process determines the status of the “preferences” field and “identity” field and determines and selects what will be forwarded to the order interface 5 for publication.

Referring again to FIG. 2, the trading system 1 also includes a communications process (FIG. 1, reference numeral 60) which enables client's accessing the system to communicate information, messages, etc. The communications and messages can be posted on the trade information interface 9. FIG. 2 shows a trade information interface view 61 showing a series of messages relating to the orders being shown at 30. This “blog” interface enables clients to communicate with each other. Reference numeral 62 shows the client identities and 63 indicates their messages. This ability to communicate with other clients increases engagement of the community in trading. Client visibility enables clients to become more engaged in the market, and can enable them to “follow” other client's market trades, and has other advantages.

The order interface 5 enables the client to associate messages with the orders they are placing. This is captured in fields in the database 10 and a tag is attached to the transaction (order) which enables the order processor and order interface to pick up the preferences and message to be displayed via the trade information interface 9.

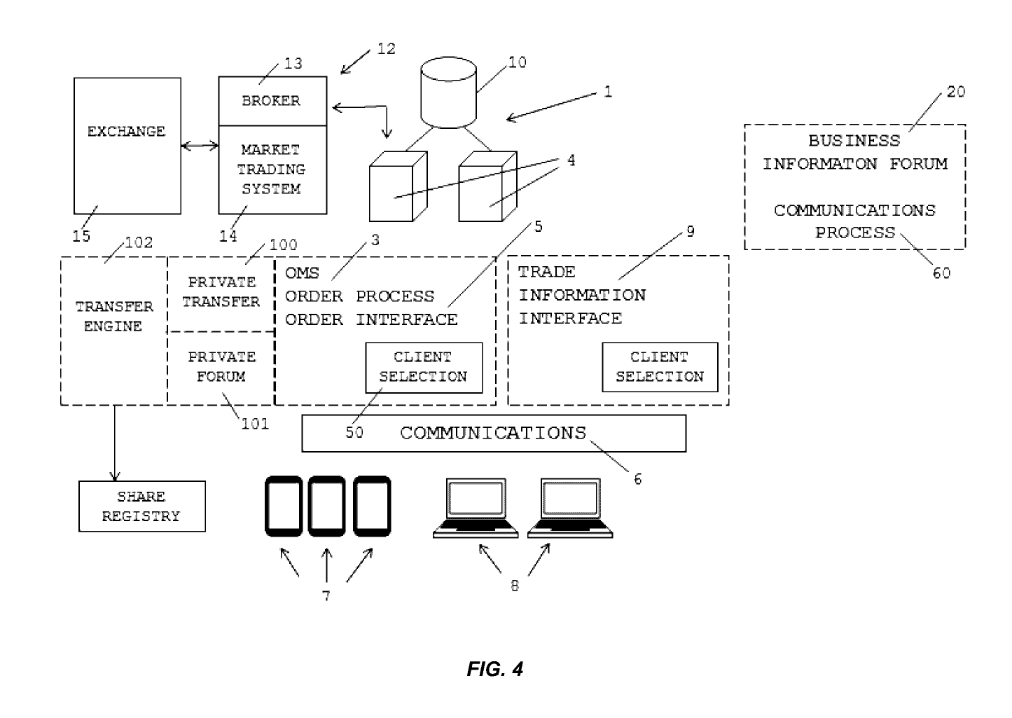

A further embodiment of the present invention will now be described, with reference to FIG. 4. FIG. 4 illustrates components of a trading system modified from that of FIG. 1. In FIG. 4, the same reference numerals are used to indicate equivalent components to the trading system of FIG. 1. No further description of these components will be given. They have the same functionality as described above, with reference to FIG. 1.

The trading system of this embodiment also comprises a private transfer process 100. The private transfer process is arranged to enable private trades to occur between clients. Clients may elect to send private messages to each other via private forum 101. Other clients may identify clients they wish to communicate with via the trade information interface and the identity information and order information appearing. They may then choose to enter a private forum for private messaging (although they may continue messaging each other publicly on the “blog”). During private messaging or otherwise, they may agree to a trade, or they may exchange any other information. If they agree to a trade, they may implement the private transfer process 100. The system may comprise a transfer engine 102 arranged to implement the private trade. The private trade may be implemented via a “dark pool”, utilising a system such as Chi-X, or via Chi-X.

Alternatively, the system may interface with an already implemented transfer engine 102 to implement the private trade. The system may update the share registry 103 by sending the appropriate information to the share registry 103.

In operation, therefore, the client may see another client's trade, via the trade information interface 9 (see reference numeral 30, FIG. 2) and decide that they would like to talk to them. They may then request the client to message them privately via private forum 101. This may be in the form of a “chat room”. In an embodiment, the system may only allow a client to join the chatroom if there is a live order in the market or the client has traded that day.

The clients can then engage with each other in the chat room and decide whether or not to implement a private transfer, or can exchange any other information.

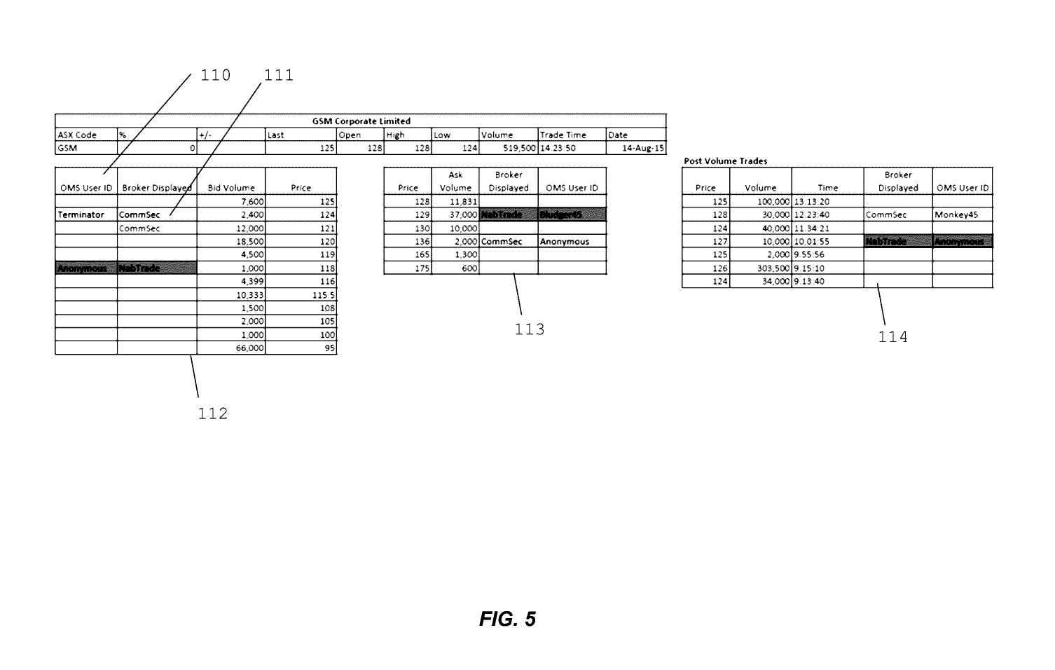

FIG. 5 shows a representation of a display which may be displayed by trading interface 9 in a further embodiment. It exemplifies a different way of displaying the identity information. As well as the column 110 for the identity of the trader, a column 111 for the identity of the broker is shown. Sections of the display are provided for bids (112), asks (113) and post-volume trades (114).

In the above embodiment, the order information is generated from an order process which is part of the trading system. In an alternative embodiment, the trading system may not include an order process. This may be provided by a separate system. Order information may be obtained from the order process and displayed on the trade information interface. The trading system 4 may not have an order management system in this embodiment.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Modifications and variations as would be apparent to a skilled addressee are deemed to be within the scope of the present invention.

What is claimed is:

1. A system for providing trade information, comprising a computer having a processor, a memory and an operating system supporting computer processes, an order process enabling a client to place orders for trading, and arranged to generate order information associated with trades, the order information including identity information on the identity of clients making the trades.

2. A system in accordance with claim 1, wherein the order process enables placing of trading orders on a stock market system.

3. A system in accordance with claim 1, wherein the order information comprises identity information on the identity of a client making the trade.

4. A system in accordance with claim 1, further comprising a client selection mechanism, enabling a client to select whether or not order information associated with them will be displayed.

5. A system in accordance with claim 1, wherein the trading system comprises a trade information interface which is arranged to display the order information for access by clients.

6. A system in accordance with claim 5, further comprising a communications process enabling clients to communicate information which may be displayed on the trade information interface.

7. A system in accordance with claim 6, where the information includes messages between clients associated with displayed orders.

8. A system in accordance with claim 1, the order process comprising a private transfer process, which is arranged to enable a private trade between clients.

9. A system in accordance with claim 1, comprising a private communications process, enabling clients to communicate with each other privately.

10. A method of providing trade information, comprising the steps of enabling a client to place orders for trade, generating order information associated with the trades, the order information including identity information on the identity of clients making the trades.

11. A method in accordance with claim 10 comprising the further step of enabling a client to select whether or not order information associated with them will be displayed.

12. A method in accordance with claim 10, comprising the further step of implementing a private transfer process, enabling a private trade between clients.

13. A method in accordance with claim 10, comprising the further step of facilitating a private communication between two or more clients, enabling them to send private messages to each other.

14. A non-volatile computer readable medium, providing instructions for controlling a computer to implement a system in accordance with claim 1.

15. A system for providing trade information, comprising a computer having a processor, a memory and an operating system supporting computer processes, an order process arranged to generate order information associated with trades, the order information including identity information on the identity of clients making the trades.

16. A method of providing trade information, comprising the steps of generating order information associated with clients trades, the order information including identity information of clients making the trades.

17. A method in accordance with claim 16, comprising the step of displaying the order information for access by clients.

18. A system for providing trade information, comprising a computer having a processor, a memory and an operating system supporting computer processes, a trade information interface enabling the provision of trade information, and a private transfer process, arranged to enable a private trade between clients having access to the system.

19. A method of providing trade information, comprising the steps of generating and displaying trade information, and implementing a private transfer process, to enable a private trade between clients.
